(19) United States
(12) Patent Application Publication
(10) Pub. No.: US 2016/0130042 A1
(43) Pub. Date: May 12, 2016

(54) CONTAINER FOR STORAGE AND TRANSFER OF POWDERED SUBSTANCES

(71) Applicant: SOURCE DESIGNS LTD., NASSAU (BS)

(72) Inventor: Jonathon Derek Gascoine, New York, NY (US)

(21) Appl. No.: 14/538,210

(22) Filed: Nov. 11, 2014

(51) Int. Cl. B65D 41/04; B65D 25/14; B65D 83/06; A61J 1/00

(52) U.S. Cl. CPC B65D 41/04; A61J 1/00; B65D 25/14; B65D 83/06

(57) ABSTRACT

A container includes a receptacle having a first opening and a second opening opposite the first opening and a through passage extending between the first and second openings, the first opening being larger than the second opening. The container also includes a first cap shaped to seal the first opening, and a second cap shaped to seal the second opening. An inner surface of the receptacle includes a pair of textured portions on opposing sides of the through passage, the textured portions being separated by smooth portions.

### BACKGROUND

This disclosure relates to containers for storing, transporting, and transferring materials such as powdered substances, in particular edible powders such as nutritional supplements and infant formula. Many nutritional powdered substances (e.g., ground or granular foods, like sugar, coffee, cocoa, powdered milk, medicinal supplements like vitamin powders, fiber powders, health formula powders and fine grained pharmaceutical substances, fitness/performance supplements like protein powders, pre- and post-workout powders, nutritional supplements like meal replacement formulas, and infant formulas, flavored drink supplements like ice tea powders, water flavorings like tang and cool aid) are sold in large containers containing many individual servings. Such containers are inconvenient for transporting and storing single servings. Conventional containers, e.g., those sold under the Tupperware® or Ziploc® brands, can be used to transport and store single servings but may be inconvenient for transferring the powdered substance, e.g., into a purchased bottle of water or juice that comprises of a screw on cap, thermos, or cup. Accordingly, containers for the convenient storage and transfer of such powdered substances are disclosed.

### SUMMARY

Various aspects of the invention are summarized as follows.

In general, in a first aspect, a container includes a receptacle having a first opening and a second opening opposite the first opening and a through passage extending between the first and second openings, the first opening being larger than the second opening. The container also includes a first cap shaped to seal the first opening, and a second cap shaped to seal the second opening. An inner surface of the receptacle includes, in some embodiments, a pair of textured portions on opposing sides of the through passage, the textured portions being separated by smooth portions.

Implementations of the container can include one or more of the following features.

In some implementations, the textured portions and the smooth portions are configured such that when the container is positioned with the first opening over the second opening and a fine grained substance is disposed within the receptacle, the fine grained substance moves towards the second opening more freely along the smooth portions than along the textured portions.

In some implementations, each textured portion includes a plurality of ridges. Each ridge can be parallel to an inner circumference of the receptacle.

In some implementations, the container further includes a first group of threads defined along the receptacle about the first opening, wherein the first group of threads are adapted to engage the first cap when the first cap is sealed to the first opening. The first group of threads can include discontinuities in a circumferential direction about the first opening. The container can further include a second group of threads defined along the receptacle about the second opening, where the second group of threads are adapted to engage the second cap when the second cap is sealed to the second opening. The second group of threads can define an outer periphery with a diameter in a range from 0.70 inches to 0.85 inches. The second group of threads can include discontinuities in a circumferential direction about the second opening. The discontinuities can be configured such that the first opening is unsealed when the first cap is rotated with respect to the container from a sealed position to an unsealed position, where the first group of threads remain engaged with the first cap in the unsealed position. The container can further include one or more external ridges extending along an outer surface of receptacle between the first opening and the second opening. The first cap can further include a seal indicator, where when first cap is in the unsealed position, the seal indicator is aligned with a marked position or a particular external ridge acts as a marker.

In some implementations, the receptacle defines a conical volume.

In some implementations, the container is adapted to retain a fine grained substance within the receptacle when the first cap is sealed to the first opening and the second cap is sealed to the second opening. The fine grained substance can be any edible substance desired to be mixed with a liquid.

In general, in another aspect, a container includes a receptacle having a first opening and a second opening opposite the first opening and a through passage extending between the first and second openings, the first opening being larger than the second opening. The container also includes a first cap shaped to seal the first opening, a second cap shaped to seal the second opening, and a group of threads defined along the receptacle about the first opening, the group of threads adapted to engage the first cap when the first cap is sealed to the first opening. The group of threads includes discontinuities in a circumferential direction about the first opening, the discontinuities configured such that the first opening is unsealed when the first cap is rotated with respect to the container from a sealed position to an unsealed position. The group of threads remain engaged with the first cap in the unsealed position.

In general, in another aspect, a container includes a receptacle having a first opening and a second opening opposite the first opening and a through passage extending between the first and second openings, the first opening being larger than the second opening. The container also includes a first cap shaped to seal the first opening, and a second cap shaped to seal the second opening. The second opening defines an outer periphery with a diameter in a range from 0.70 inches to 0.85 inches.

In general, in another aspect, a container includes a receptacle having a first opening and a second opening opposite the first opening and a through passage extending between the first and second openings, the first opening being larger than the second opening. The container also includes a first cap shaped to seal the first opening, a second cap shaped to seal the second opening, and a group of threads defined along the receptacle about the second opening, the group of threads adapted to engage the second cap when the first cap is sealed to the second opening. The group of threads includes discontinuities in a circumferential direction about the second opening.

Among other advantages, embodiments can provide a convenient vessel for storing, transporting, and transferring fine grained substances. For example, certain embodiments can be used to conveniently transfer substances stored within the container (e.g., a powdered nutritional supplement) into a receiving container (e.g., a water bottle) by sizing the output nozzle to fit securely within the receiving container's opening. As yet another example, certain embodiments can facilitate easier transfer of a substance from the container into a receiving container by providing channels through which displaced air from the receiving container can exit or vent. As yet another example, certain embodiments can reduce the likelihood of the container clogging during the transfer of substances. For instance, the container can include textured portions. For example, in some embodiments, the container can include textured portions and smooth portions that cause the powder to flow across those portions at different rates. In this way, clogging of the container at its output nozzle can be reduced. Other embodiments can include textured portions that are continuous around a circumferential section of the container. As yet another example, certain embodiments allow the container to be unsealed without fully detaching a sealing cap, reducing the likelihood of spillage through an uncapped opening or that the cap becomes lost. For instance, the threads with discontinuities may be structured so that when the larger cap is opened with, e.g., approximately a quarter twist to align with markers to allow for the internal alignment of the threads allowing for the alignment of the unthreaded portions of the cone and the inside cap. This may allow for air to enter into the container facilitating the dispensing of the stored powdered substance by eliminating any vacuum that may arise when the stored substance level is exiting the container. These and other features may also facilitate ease of use in that the container may be easily connected to a bottle and its contents emptied into the bottle with one hand, allowing the user's free hand to grip the bottle.

The details of one or more implementations are set forth in the accompanying drawings and the description below. Other features and advantages will be apparent from the description and drawings, and from the claims.

### DESCRIPTION OF DRAWINGS

FIG. 1A is a perspective view of an example container with the caps separated.

FIG. 1B is a perspective view of the container shown in FIG. 1A with the caps attached.

FIG. 1C is a perspective view of an example screw thread.

FIG. 2A is a perspective view of another example of a container.

FIG. 2B is a cross-sectional view of the container shown in FIG. 2A, showing the profile of a ridge.

FIG. 3A is a perspective view of a lower portion of an example container.

FIG. 3B is a perspective view of an upper portion of an example container.

FIG. 4A is a cross-sectional view of an example cap.

FIG. 4B is an overhead view of an example cap.

FIG. 4C is a side view of the cap shown in FIG. 4A.

FIG. 5A is a frontal cross-section view of an example container.

FIG. 5B is a cross-sectional view of the container shown in FIG. 5A, showing the profile of an example textured portion.

FIG. 5C is a side cross-section view of the container shown in FIG. 5A.

FIG. 6A is a side view of an example container.

FIG. 6B is a side view of the receptacle shown in FIG. 6A.

FIG. 6C is a cross-sectional view of the receptacle shown in FIG. 6A.

FIGS. 6D-E show cross sectional views of detailed portions of the receptacle shown in FIG. 6C.

FIG. 6F shows a bottom view of the receptacle shown in FIG. 6A.

FIG. 6G shows a top view of the receptacle shown in FIG. 6A.

FIG. 6H shows a top view of the first cap shown in FIG. 6A.

FIG. 6I shows a bottom view of the first cap shown in FIG. 6H.

FIG. 6J shows a side view of the first cap shown in FIG. 6H.

FIG. 6K shows a cross-sectional view of the first cap shown in FIG. 6H.

FIG. 6L shows a cross-sectional view of a detailed portion of the first cap shown in FIG. 6H.

FIG. 6M shows a top view of the second cap shown in FIG. 6A.

FIG. 6N shows a bottom view of the second cap shown in FIG. 6M.

FIG. 6O shows a side view of the second cap shown in FIG. 6M.

FIG. 6P shows a cross-sectional view of the second cap shown in FIG. 6M.

FIG. 6Q shows a cross-sectional view of a detailed portion of the second cap shown in FIG. 6M.

FIG. 7A is a side view of another example container.

FIG. 7B is a side view of the receptacle shown in FIG. 7A.

FIG. 7C is a cross-sectional view of the receptacle shown in FIG. 7A.

FIGS. 7D-E show cross sectional views of detailed portions of the receptacle shown in FIG. 7C.

FIG. 7F shows a bottom view of the receptacle shown in FIG. 7A.

FIG. 7G shows a top view of the receptacle shown in FIG. 7A.

FIG. 7H shows a top view of the first cap shown in FIG. 7A.

FIG. 7I shows a bottom view of the first cap shown in FIG. 7H.

FIG. 7J shows a side view of the first cap shown in FIG. 7H.

FIG. 7K shows a cross-sectional view of the first cap shown in FIG. 7H.

FIG. 7L shows a cross-sectional view of a detailed portion of the first cap shown in FIG. 7H.

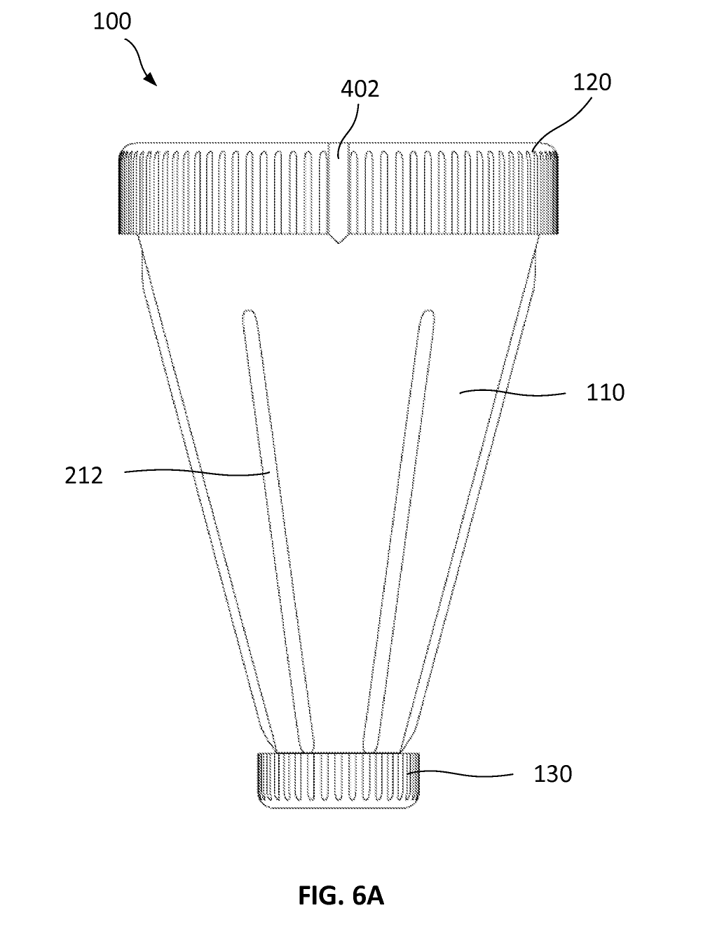

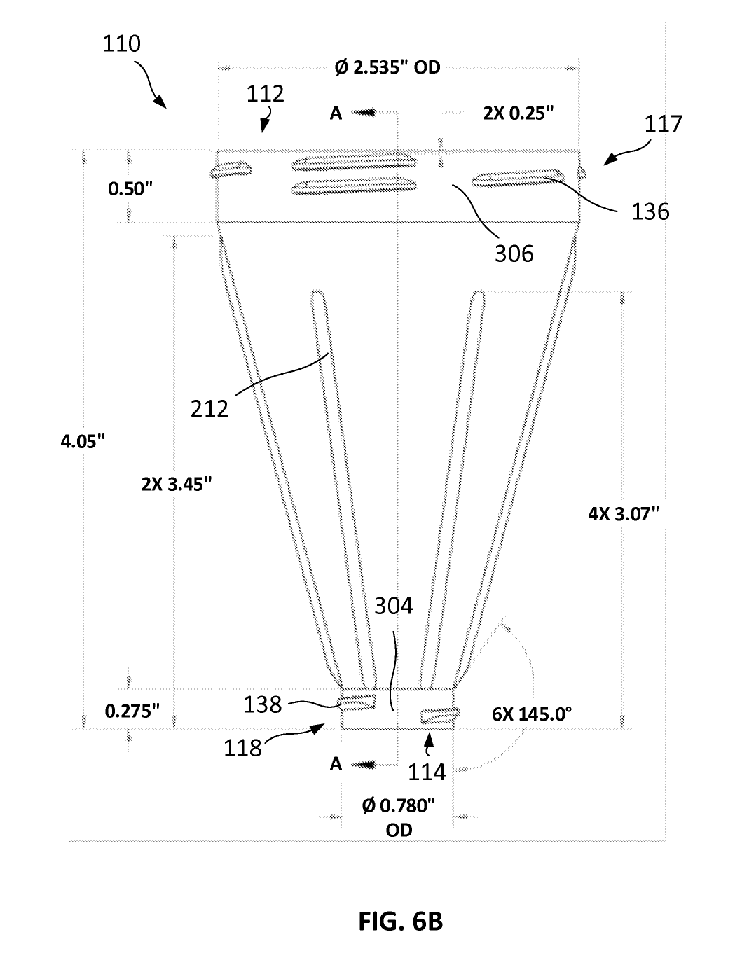

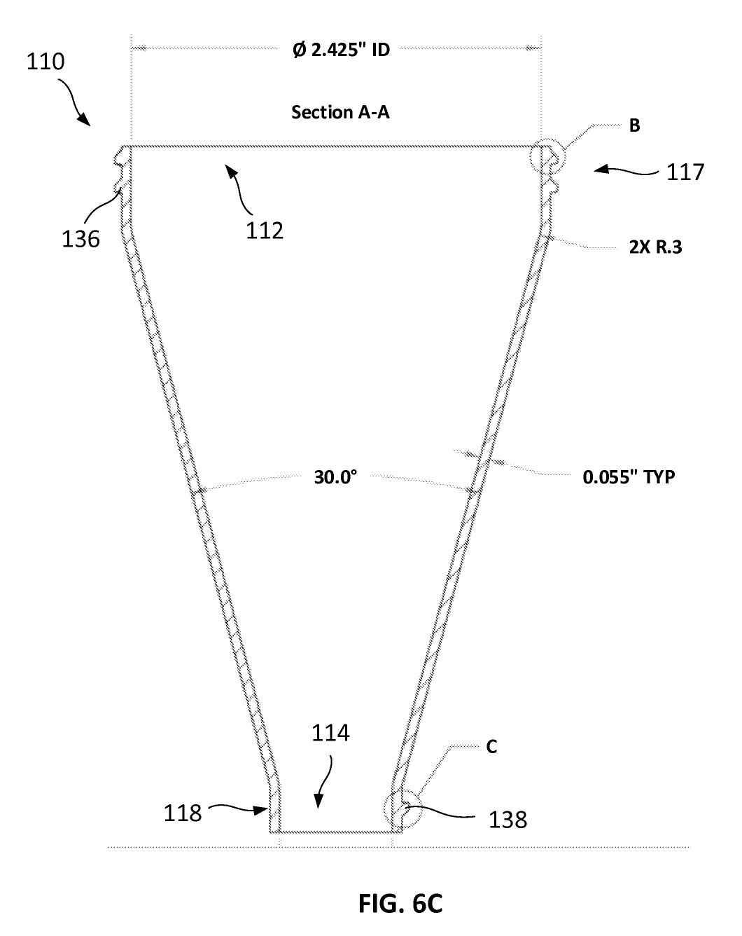

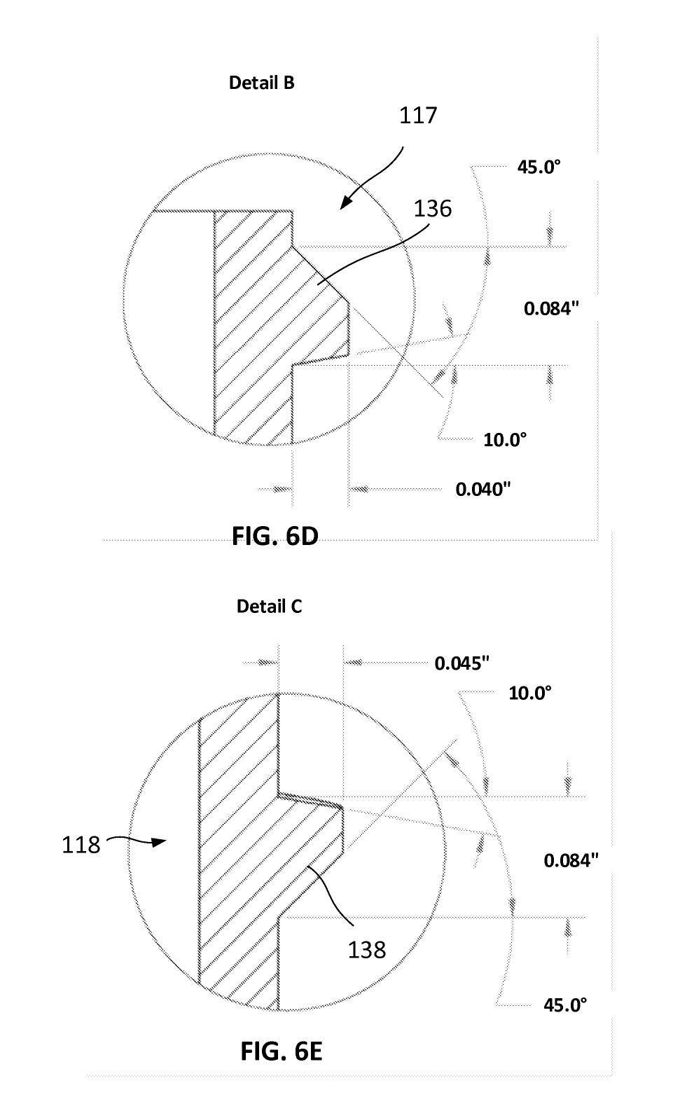

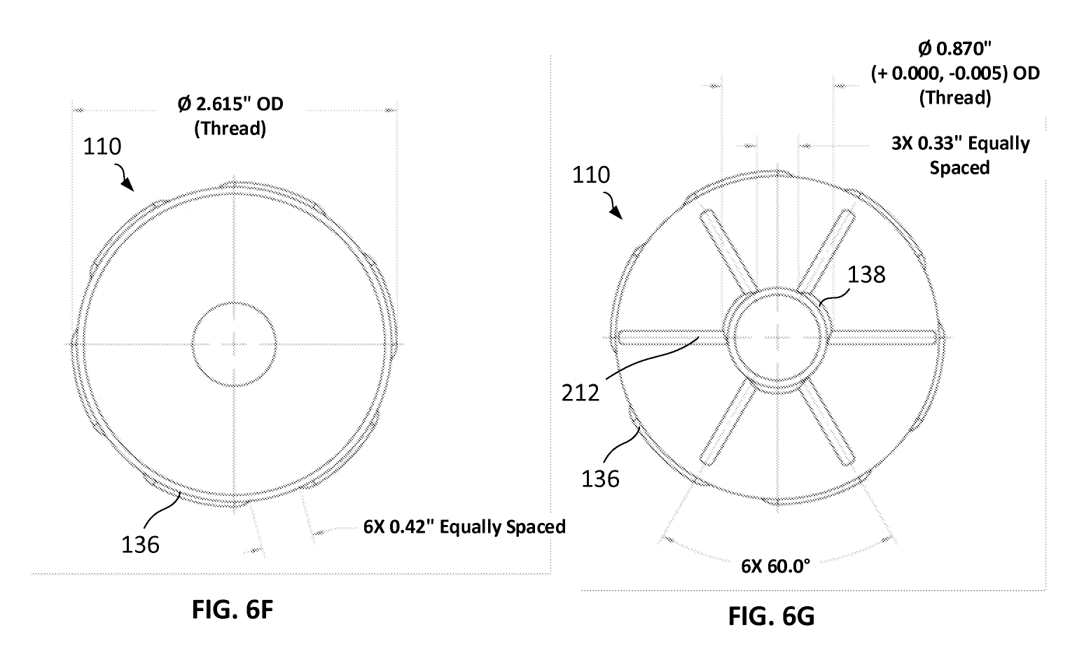

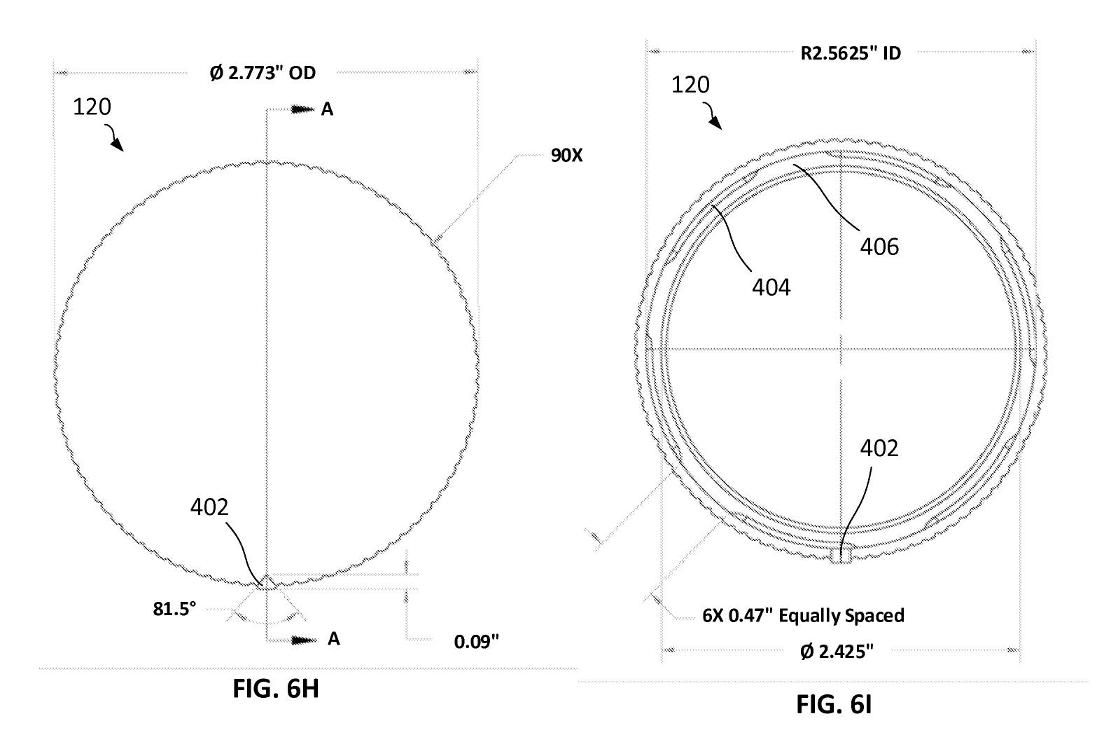

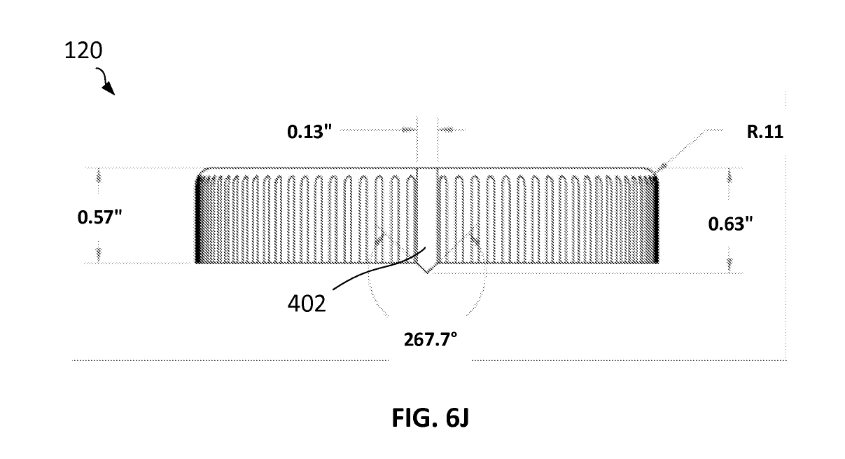

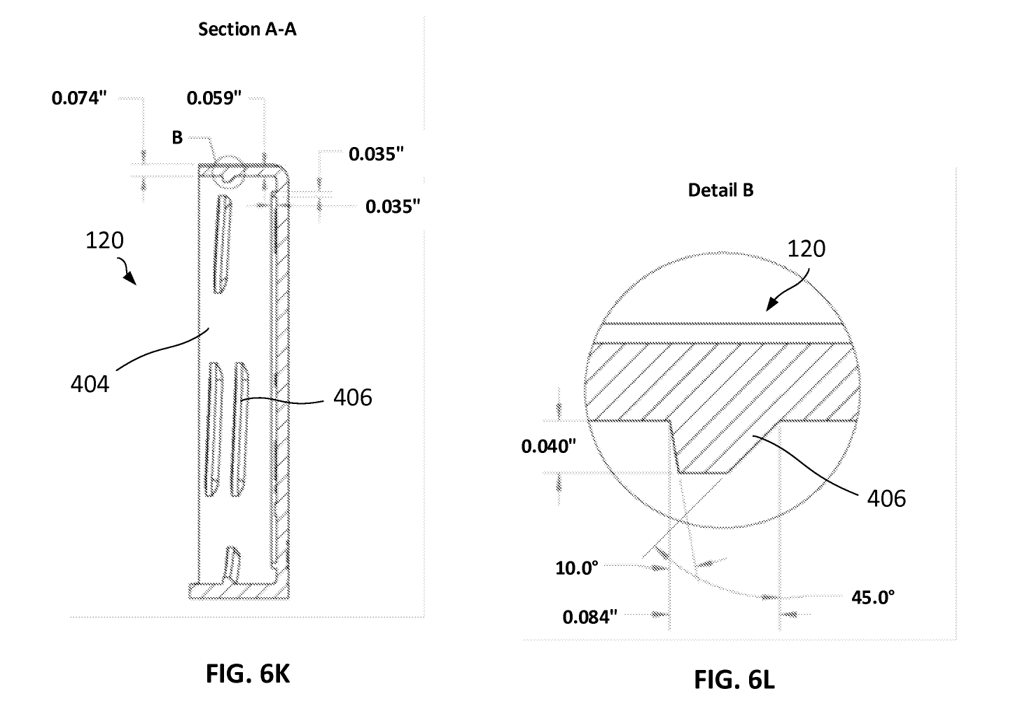

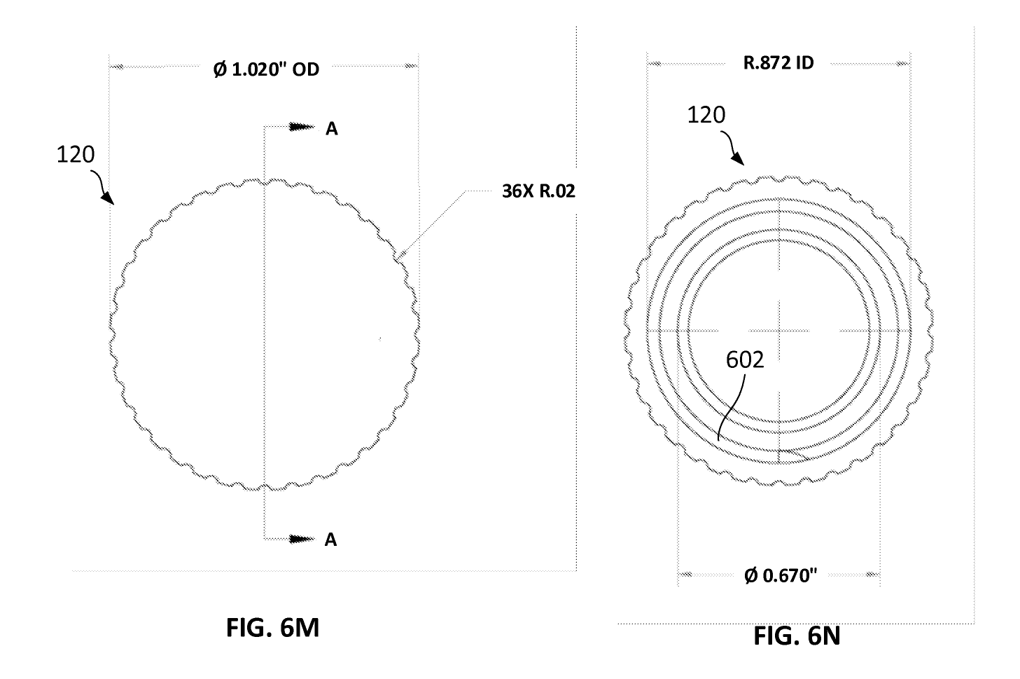

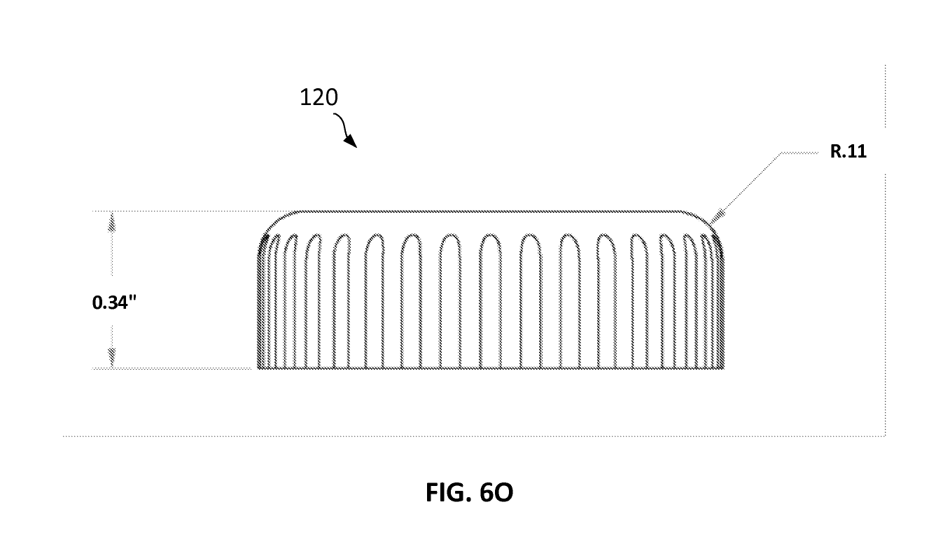

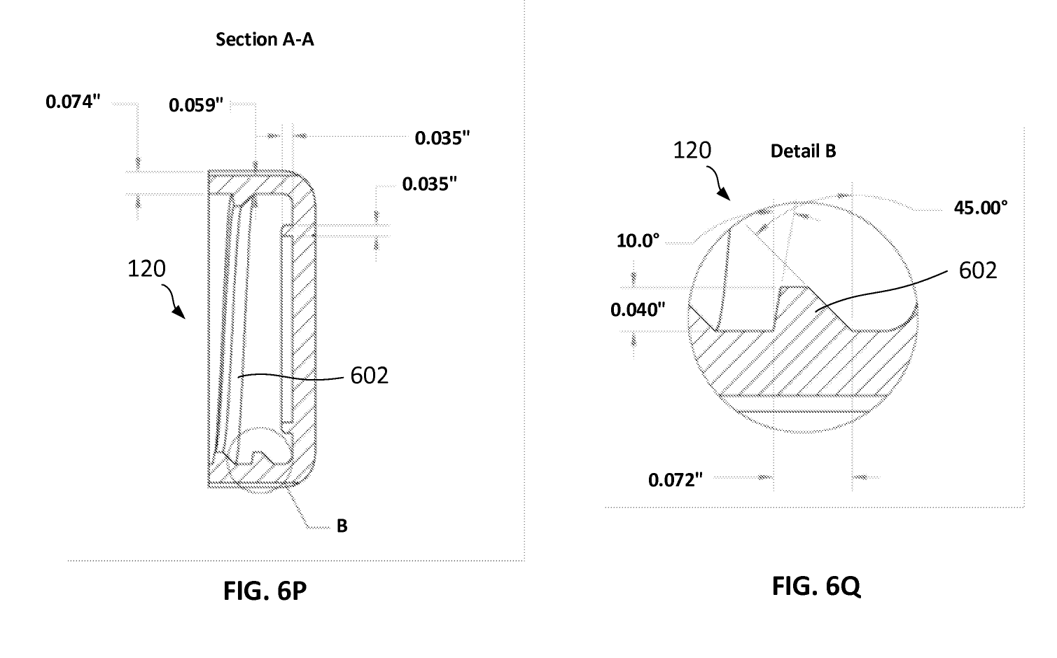

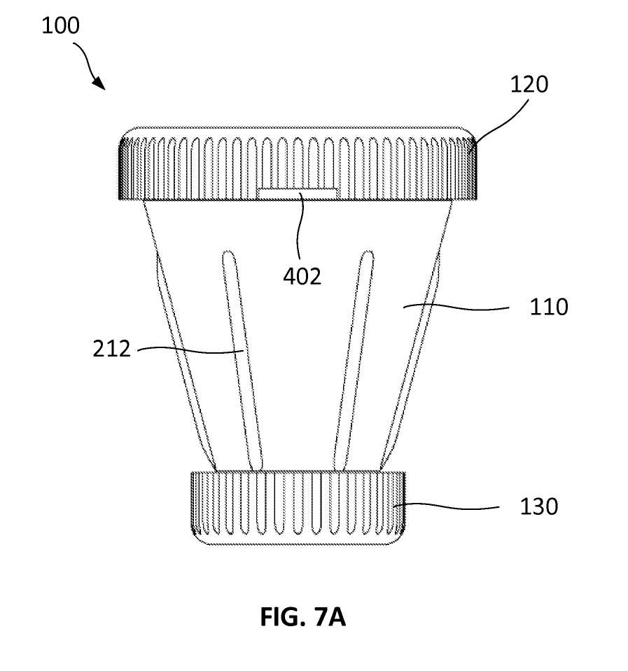

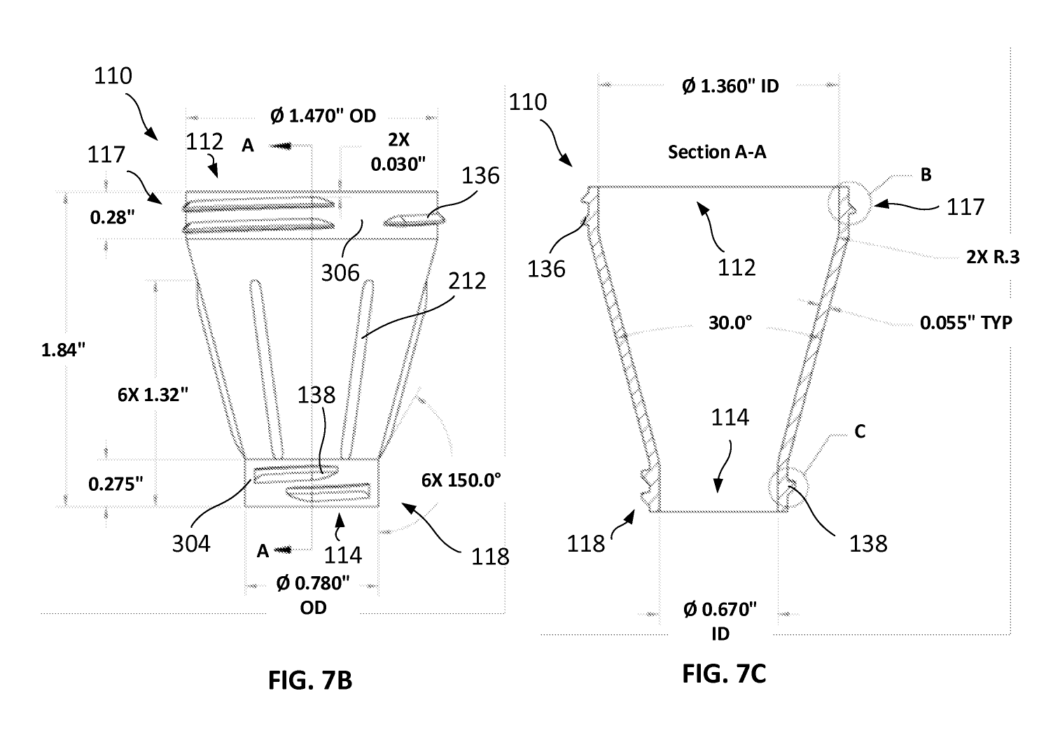

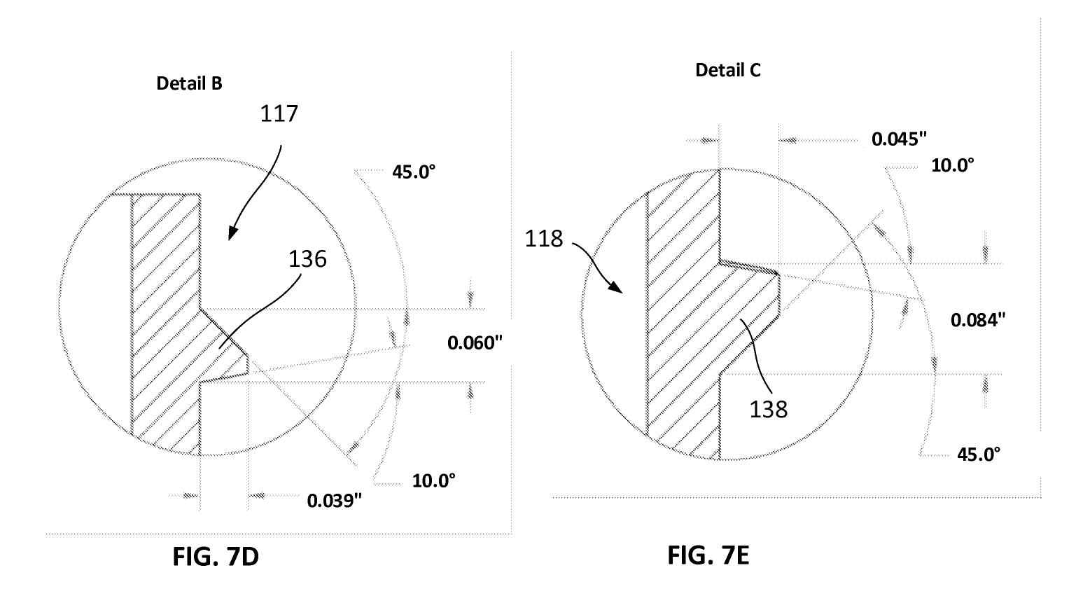

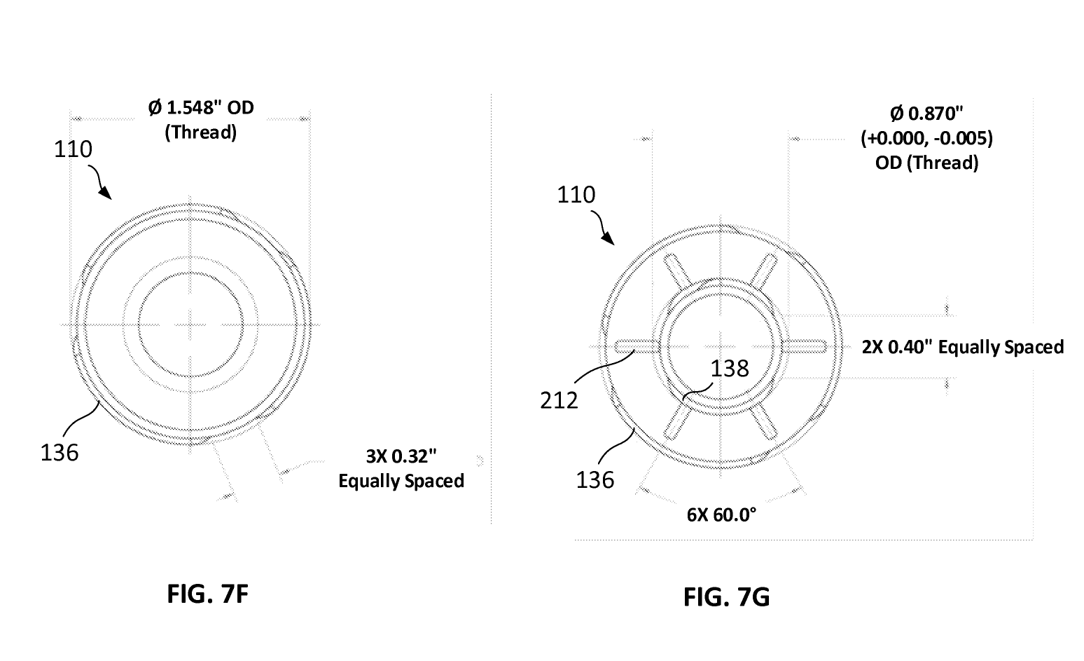

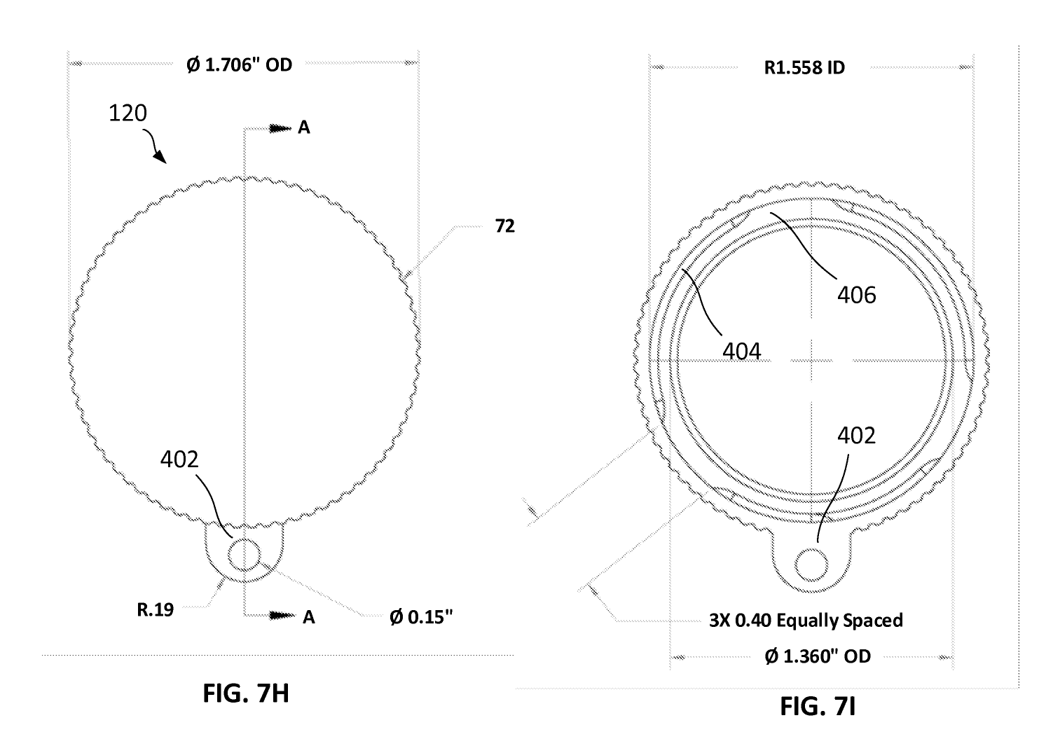

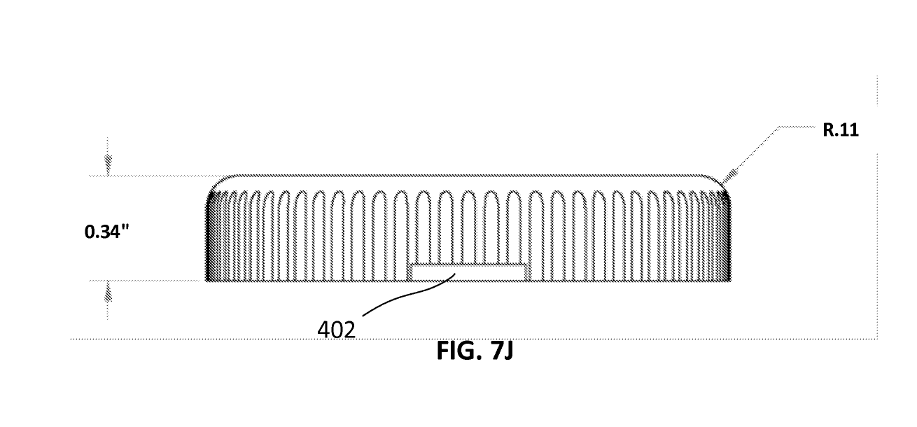

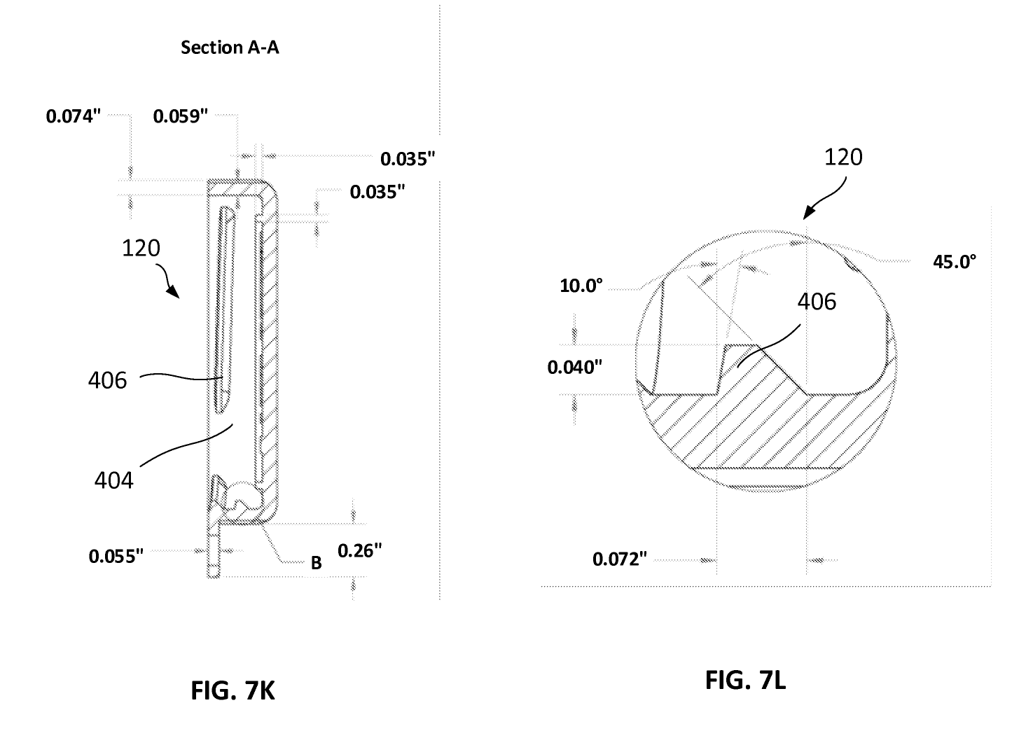

FIGS. 6A-Q and FIGS. 7A-L are each drawn to scale.

Like reference symbols in the various drawings indicate like elements.

### DETAILED DESCRIPTION

Implementations of a container are described below. In an example implementation, a container includes two openings and two corresponding caps that seal the two openings. When the openings are sealed, the container can be used to securely transport substances such as liquids (e.g., water, juice, milk, syrup, or other liquids), powders (e.g., nutritional supplements, infant formulas, sugar, salt, flour, or other fine-grained substances), or small objects (e.g., candy, nuts, seeds, rice, cereal, other small objects). When the openings are unsealed (e.g., by removing the caps), the contents of the container can be removed. For example, the container can be positioned over a receiving container (e.g., a water bottle, canteen, jug, bowl, or box), and one or both of the openings unsealed, such that the contents of the container flow into the receiving container under gravity. In some implementations, the container can be configured to transfer a single serving of a dry edible powder (e.g., a nutritional supplement or infant formula) into a liquid-filled container that has a capped lid (e.g., a purchased bottle of water or juice) so that a beverage can be reconstituted for consumption. For example, the container can be used by a person to conveniently store and transport a serving of a nutritional supplement, like a protein powder, a nutraceutical, or a powdered pharmaceutical substance and transfer the contents into a water bottle when the person is ready to consume the serving.

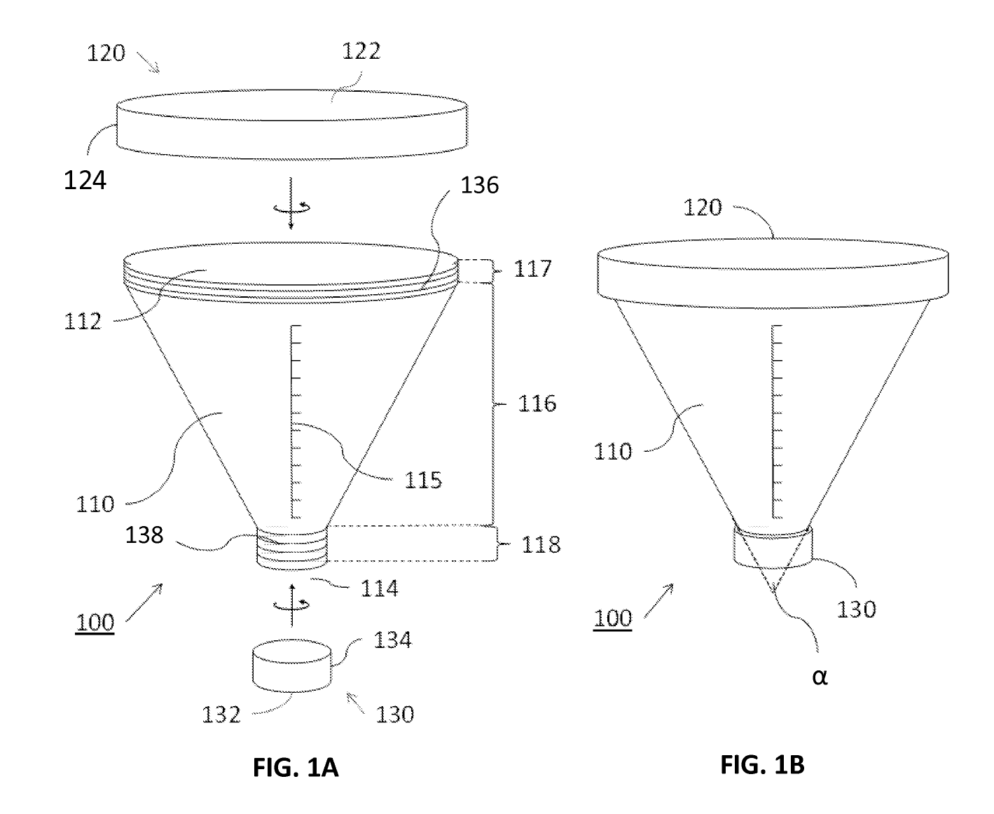

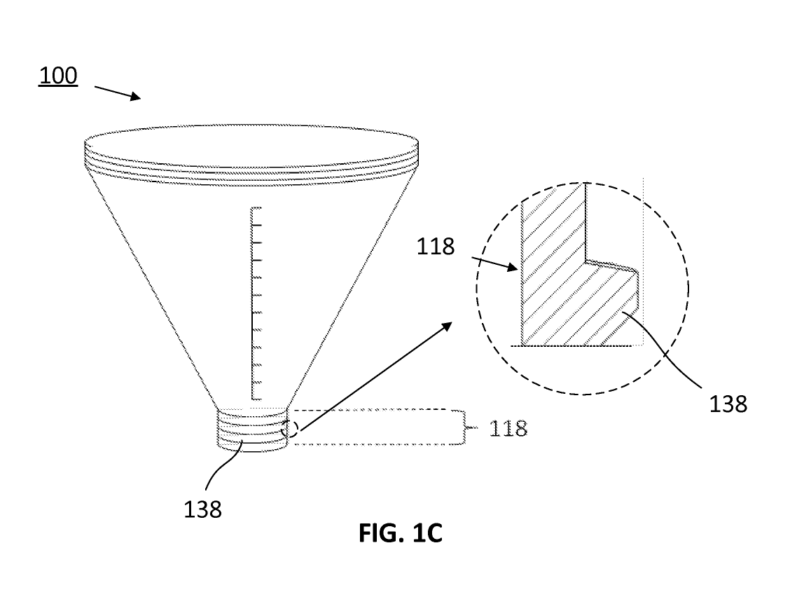

Referring to FIGS. 1A-B, an example implementation of a container 100 is composed of a receptacle 110, a first cap 120, and a second cap 130. Receptacle 110 is a pipe including a conical section 116 (e.g., a frustum) between a two cylindrical sections 117 and 118. FIG. 1A shows container 100 with caps 120 and 130 detached from receptacle 110. FIG. 1B shows the caps attached. At one end, receptacle 110 has a wide opening 112. At the opposite end, the receptacle has a narrower opening 114. In the present embodiment, the diameter of receptacle 110 decreases monotonically from along the length of conical section 116. Cylindrical sections 117 and 118 include screw threads 136 and 138, respectively, on their outer surfaces for securing the receptacle 110 to caps 120 and 130, respectively.

Caps 120 and 130 each include a disc-shaped planar portion (122 and 132, respectively) and a cylindrical portion (124 and 134, respectively). Disc-shaped planar portions 122 and 132 are sized to cover openings 112 and 114, respectively. Cylindrical portions 122 and 134 include screw threads on their inner surfaces that mate to the screw threads 136 and 138, respectively, allowing one to detachably secure the caps to and detach the caps from the receptacle 110 by rotating the caps 120 and 130 with respect to the receptacle 110. When attached, caps 120 and 130 seal the openings 112 and 114 so that a substance (e.g., a liquid or powder) in the receptacle volume does not leak out. In some implementations, the caps can include an O-ring seal to facilitate a good seal with the receptacle 110.

Receptacle 110 also includes a scale 115, allowing one to meter the amount of liquid or other substance placed into container 100. The scale 115 can be, for example, a set of markings that are printed onto the receptacle 110 (e.g., markings printed onto the interior or exterior of the receptacle 110), one or more elements molded into the receptacle 110 (e.g., elements formed as integral portions of the receptacle 110), or one or more elements affixed onto the receptacle 110 (e.g., a label or other element affixed onto the receptacle 110).

In general, the volume and shape of receptacle 110 can vary as desired and can depend on the intended use for the container. As an example, the receptacle volume can be in a range from 10 ml to 1 liter (e.g., 20 ml, 50 ml, 60 ml, 70 ml, 80 ml, 90 ml, 100 ml, 150 ml, 200 ml, 250 ml, 300 ml, 500 ml) or more (e.g., 2 liters, 4 liters). In some embodiments, the receptacle volume corresponds to a single serving of a nutritional supplement. For example, the receptacle volume can be in a range from one-quarter to one standard cup measure. As another example, the receptacle volume can be approximately 10.5 cubic inches (e.g., between 10-11 cubic inches). As yet another example, the receptacle volume can be approximately 1.5 cubic inches (e.g., between 1-2 cubic inches).

The size of each opening can also vary as desired. Generally, the inner diameter of smaller opening 114 should be sufficient to allow the stored substance to readily flow through the opening, e.g., under gravity. In some implementations, smaller opening 114 has an inner diameter in a range from 0.5 cm to 5 cm (e.g., 0.75 cm, 1 cm, 1.5 cm, 2 cm, 2.5 cm) or more (e.g., 6 cm, 10 cm).

In some implementations, wide opening 112 can have an inner diameter in a range from 2 cm to 10 cm (e.g., 3 cm, 4 cm, 5 cm, 6 cm, 7 cm, 8 cm) or more (e.g., 15 cm, 20 cm). Generally, the inner diameter of opening 112 should be sufficiently large to facilitate easy transfer of the substance to be stored into the container. In general, the ratio between the inner diameter of the wide opening to the inner diameter of the smaller opening can be 2-to-1 or more (e.g., 3-to-1 or more, 4-to-1 or more, 5-to-1 or more).

In an example implementation, the smaller opening has an inner diameter of approximately 0.67 inches (e.g., between 0.5 inches to 1 inch), the wide opening has an inner diameter of approximately 2.425 inches (e.g., between 2 inches and 3 inches). In another example implementation, the smaller opening has an inner diameter of approximately 0.67 inches (e.g., between 0.5 inches to 1 inch), the wide opening has an inner diameter of approximately 1.360 inches (e.g., between 1 inch and 1.5 inches). In some implementations, the cylindrical section 117 (including screw threads 136) can have an outer diameter in a range from 0.5 cm to 5 cm (e.g., 0.75 cm, 1 cm, 1.5 cm, 2 cm, 2.5 cm) or more (e.g., 6 cm, 10 cm).

In some implementations, the cylindrical section 118 (including screw threads 138) can have an outer diameter in a range from 2 cm to 10 cm (e.g., 3 cm, 4 cm, 5 cm, 6 cm, 7 cm, 8 cm) or more (e.g., 15 cm, 20 cm).

In some implementations, the cylindrical sections 117 and/or 118 can have an outer diameter that corresponds to the opening of one or more receiving containers. For example, the cylindrical section 118 (including screw threads 138) can have an outer diameter of between 8 inches to 0.85 inches (e.g., approximately 0.825 inches), such that the cylindrical section 118 can be inserted into the opening of a receiving container (e.g., a bottle, jug, canteen, jug, or other container) having an opening with an inner diameter in this range. In some implementations, a cylindrical section 118 with an outer diameter of in this range allows the cylindrical section 118 to be inserted into many different types of commercially available containers (e.g., commercially available water bottles or other commercially available beverage containers such as 16.9 oz water bottles, e.g., those sold under the Dasani brand, from the Coca-Cola Company). In this manner, the contents of the container 100 can be transferred to many different types of commercially available containers in a manner that minimizes spillage or waste. Also, having the outer diameter of cylindrical section 118 snugly fit within the inner diameter of an opening of a commercially-available bottle allows the container to be held in place in the bottle opening without having to maintain a hand hold on the container.

An example screw thread 138 is shown in FIG. 1C. In this example, the outer diameter of cylindrical section 118 (without the screw thread 138) is 0.78 inches, and the screw thread 138 has a thickness of 0.45 inches. Thus, in total, the cylindrical section 118 (including screw thread 138) has an outer diameter of 0870 inches. As another example, in some implementations, in total, the cylindrical section 118 (including screw threads 138) has an outer diameter of approximately 0.750 to 0.870 inches. Although an example implementation of a cylindrical section 118 and a screw thread 138 is shown in FIG. 1C, this is merely an example. In practice, a cylindrical section 118 and a screw thread 138 can have different dimensions and shapes, depending on the implementation.

The length (i.e., distance between the openings) of the receptacle can also vary as desired. In certain implementations, the length of the receptacle is in a range from about 4 cm to about 15 cm (e.g., about 5 cm, about 7.5 cm, about 10 cm, about 12 cm). Other lengths are also possible (e.g., about 20 cm or more, about 30 cm or more, about 50 cm or more).

In some implementations, the ratio between the length of the container and the diameter of the wide opening can be 1-to-1 or more (e.g., 4-to-3 or more, 3-to-2 or more, 2-to-1 or more, 3-to-1 or more, 4-to-1 or more, 5-to-1 or more, 6-to-1 or more).

In an example implementation, the container has a length of approximately 4.05 inches (e.g., between 3.5 and 4.5 inches). As another example, in some implementations, the container has a length of approximately 1.84 inches (e.g., between 1.5 inches and 2.0 inches).

The cone angle a of conical section 116 can vary as desired. The cone angle a refers to the angle the conical section would form if extended to an apex. Generally, the cone angle a should be sufficiently low so that the material in the receptacle 110 can flow out of the small opening under gravity when the small opening faces downward. In some implementations, the cone angle a can be in a range from 10° to 90° (e.g., 15°, 20°, 25°, 30°, 45°, 75°, 60°) or more (e.g., 100°, 125°). In an example implementation, the cone angle α is approximately 30° (e.g., between 25° and 35°.

In some implementations, conical section 116 includes portions having different cone angles. For example, section 116 can include a portion adjacent wide opening 112 having a first cone angle (e.g., a larger cone angle), while a portion adjacent opening 114 has another cone angle (e.g., a smaller cone angle), e.g., forming a spout. In some implementations, conical section 116 can have more than two portions, each portions having a similar or different cone angle than one or more other portions.

Although example volumes, dimensions, and angles are described above, these are provided merely as examples. In practice, the volume, dimensions, and angles of the container 100 can vary depending on the application. Similarly, although the container 100 is described has having a conical section 116, in practice container 100 can be of any suitable shape. For example, in some implementations, the container 100 can include non-conical elements, such as polyhedrons, spheres, and/or arbitrarily defined volumes, or one or more partial portions thereof. Further, although the container 100 is described as having a receptacle 110 with a diameter that decreases monotonically along the length of the conical section 116, in some implementations, the diameter of the receptacle 110 can decrease non-monotonically. For example, in some implementations, the receptacle 110 can generally narrow along the length of the conical section 116 from the wide opening 112 to the narrower opening 114, but can also widen along certain portions of the conical section 116.

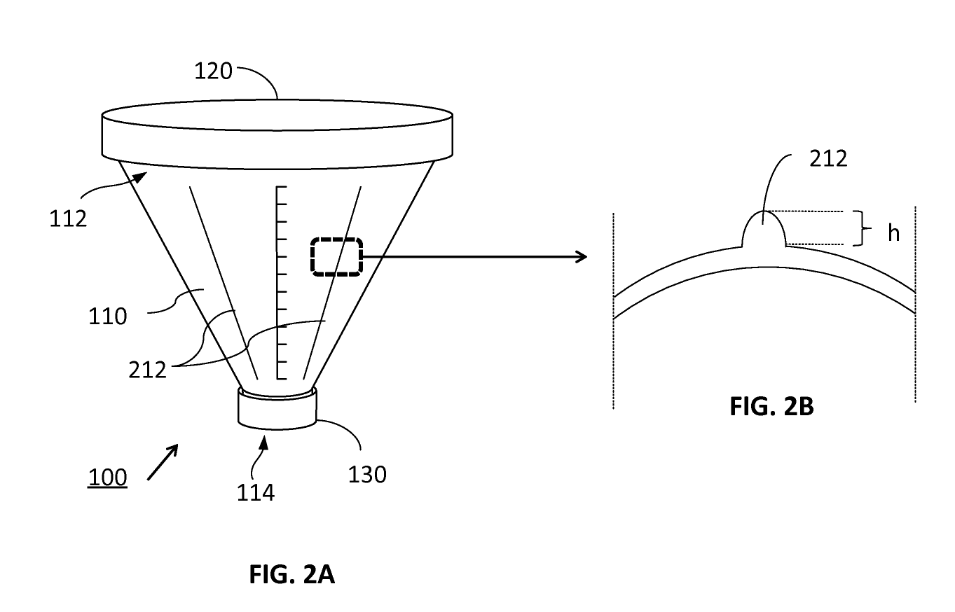

While the containers described above have smooth outer walls, other form factors are also possible. For example, in some implementations, the outer wall of the receptacle 110 can include ridges or grooves extending between the two openings. For instance, referring to FIGS. 2A and 2B, another example implementation of container 100 includes a receptacle 110 that has ridges 212 on its outer surface. Ridges 212 run between the openings 112 and 114 and protrude a height, h, from the surface of receptacle 110. Generally, h can vary. In some implementations, h is in a range from 0.1 mm to 3 mm (e.g., 0.2 mm, 0.3 mm, 0.5 mm, 0.8 mm, 1 mm). As another example, the container 100 can include grooves that recess into the outer surface of receptacle 110 a depth d, either in additional to or instead ridges 212. Generally, d can also vary. In some implementations, d is in a range from 0.1 mm to 3 mm (e.g., 0.2 mm, 0.3 mm, 0.5 mm, 0.8 mm, 1 mm). In an example implementation, the container 100 includes ridges having a height h of approximately 0.22 inches (e.g., between 0.17 inches and 0.27 inches).

Ridges or grooves may be beneficial in some circumstances, as they can provide separation between the outer wall of the container and the inner surface of a receiving container into which the container is inserted to transfer material. The separated surfaces provide channels through which displaced air from the receiving container can exit or vent from the receiving container. This can facilitate easier funneling of liquid or powder into the receiving container as displaced air can exit the receiving container through channels other than the container.

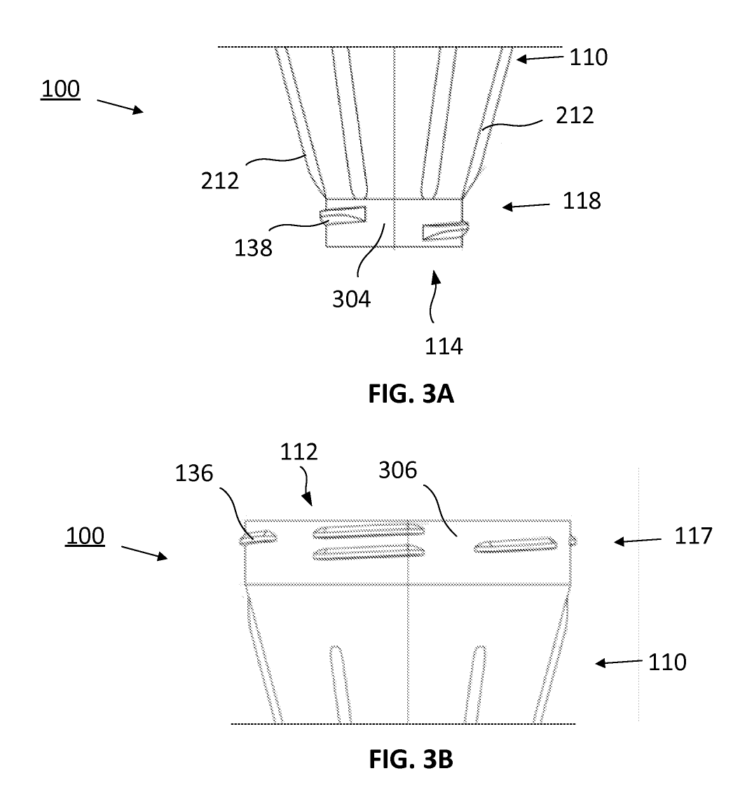

In some implementations, when the container includes threaded portions (e.g., screw threads for securing caps to each of the openings), the threading may include discontinuities or undulations to prevent the threading from forming a seal with the opening of a receiving container. For example, FIG. 3A shows a lower portion of an example implementation of container 100 that includes screw threads 138 positioned along the cylindrical portion 118, and further includes several discontinuities 302 defined through the screw threads 138 in a circumferential direction about the opening 114. In an example usage, when the container 100 is inserted into the opening of a receiving container, even if the screw threads 138 contact the opening of the receiving container, the discontinuities 302 allows for the passage of air through the screw threads 138. In this manner, as substances are transferred between the container 100 and the receiving container, displaced air is able to freely vent from the containers via the discontinuities 302, allowing the substances to transfer freely without interference.

In some implementations, container 100 can include both ridges and screw threads with discontinuities. For example, as shown in FIG. 3A, the container 100 includes several ridges 212 and the screw threads 138 with discontinuities 302. When the container 100 is inserted into the opening of a receiving container, the ridges 212 prevent the outer surface of the receptacle 110 from forming a seal with the opening of the receiving container. In a similar manner, the discontinuities 302 prevent the screw threads 138 from forming a seal with the opening of the receiving container. Thus, even when the container 100 is inserted into a receiving container and positioned flush against the receiving container, air is still able to freely vent from the containers, allowing the substances to transfer freely without interference.

In some implementations, the threaded portions along the top of the container (e.g., the threaded portion 136) can also include discontinuities. For example, FIG. 3B shows an upper portion of an example implementation of container 100 that includes screw threads 136 positioned along the cylindrical portion 117, and further includes several discontinuities 306 defined through the screw threads 136 in a circumferential direction about the opening 112.

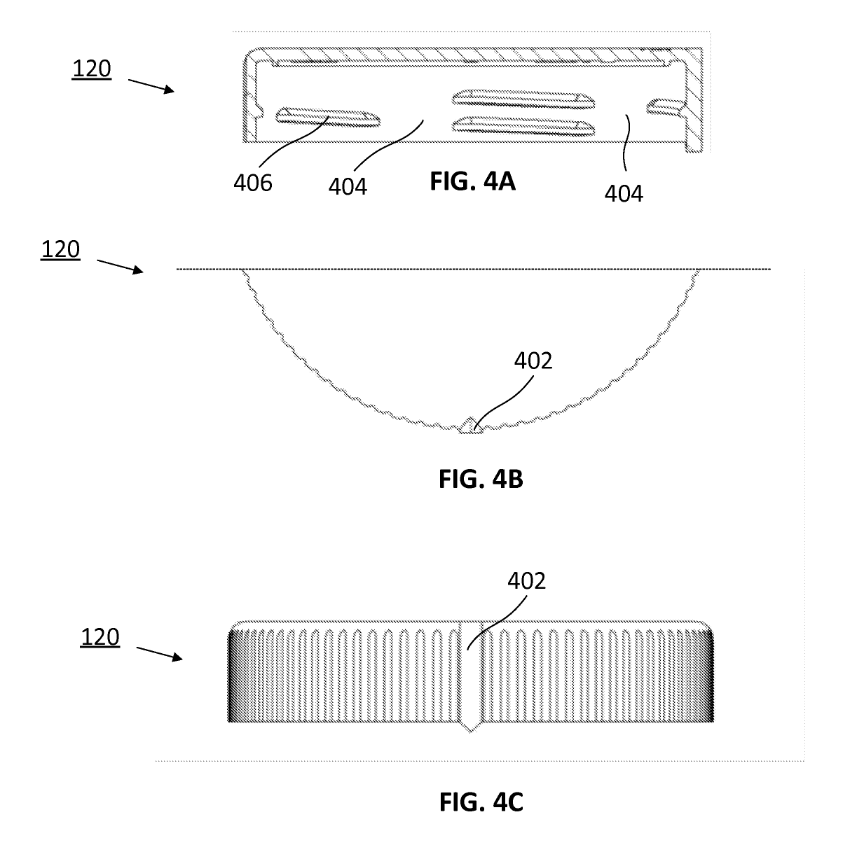

In some implementations, the discontinuities 306 allow the opening 112 to become unsealed without necessitating full removal of the cap 120. For example, discontinuities 306 can be arranged such that when the cap 120 is fully tightened along the screw threads 136, the opening 112 is fully sealed, and no air can vent through the discontinuities 306. When the cap 120 is rotated by a particular angular distance (e.g., a quarter turn, or 90°), the discontinuities 306 are aligned with corresponding discontinuities 404 between threads 406 of the cap 120 (as shown in cross-section in FIG. 4A), allowing air to vent through the discontinuity 306 and the discontinuity 404 of the cap 120. However, in this position, certain of the threads 136 on the cylindrical portion 117 remain engaged with corresponding threads on the cap, so that the cap remains secured to receptacle 110. In this manner, the opening 112 can be unsealed without fully removing the cap 120 from the container 100. This can be beneficial in particular circumstances, for example when a user wishes to unseal opening 112 so that substances can be more easily transferred from the container 100 to a receiving container without interference, while ensuring that the cap 120 remains physically attached to the container 100 so that it is not separated and potentially lost.

In some implementations, the cap 120 can include an indicator element that indicates when the cap 120 is in a sealed position against the opening 112 and when the cap 120 is in an unsealed position away from the opening 112. For example, FIGS. 4B-C show an overhead view (FIG. 4B) and a side view (FIG. 4C) of an example implementation of cap 120 includes an indicator element 402. As shown in FIGS. 4B-C, in some implementations the indicator element 402 can be integral with the cap 120 (e.g., molded as a part of the cap 120). In some implementations, the indicator element 402 can be a separate element (e.g., a separate element that is affixed to the cap 120), or can be painted or marked onto the cap 120 (e.g., using a color contrasting paint or ink).

In an example usage, when the cap 120 is positioned over the opening 112, the indicator element 402 indicates the angular position of the cap 120 with respect to the receptacle 110. As the cap 120 is rotated (e.g., in a manner that tightens it or loosens it from the receptacle 110), the indicator traverses along the circumferential periphery of the receptacle 110. The receptacle 110 can include a corresponding set of reference markings that indicates when the cap 120 is in a sealed position against the opening 112 and when the cap 120 is in an unsealed position away from the opening 112. In some implementations, one or more of the ridges 212 can be used as references markings As an example, the ridges 212 can be arranged about the receptacle 110 such that when the cap 120 is in a sealed position against the opening 112, the indicator element 402 is aligned a particular ridge 212. Likewise, when the cap 120 is in an unsealed position away from the opening 112, the indicator element 402 is not aligned with that particular ridge 212 (e.g., aligned with a different ridge 212, or not aligned with any ridge at all). In practice, other combinations of alignment or non-alignment between the indicator element 402 and particular ridges 212 also can be used to indicate when the cap 120 is sealed or unsealed.

While the foregoing containers use threading to secure the caps to the receptacle, other securing mechanisms are also possible. For example, snap-on caps can be used, such as those found in many commercially-available storage containers, such as containers branded Tupperware® or Rubbermaid®. Snap-on caps can be fixedly attached to the receptacle at each end with a hinge element. Generally, any securing mechanism that provides the user with the ability to easily (e.g., using only their hands) and repeatedly remove and secure the caps to the receptacle, and that adequately seal the container can be used.

While the caps described above are intended to repeatedly seal and un-seal the receptacle openings, in some embodiments the openings can be sealed with a single use seal, such as an aluminum foil seal secured to the receptacle at the openings by a releasable adhesive. The foil seal can include a tab to facilitate removal. The foil seal can be similar to those use in commercially-available food containers, such as yoghurt containers. In some embodiments, a cap, e.g., a snap-on cap, can be provided at one or both openings in addition to a removable seal.

In some implementations, the container 100 can include threads 138 and discontinuities 304, even if the container 100 does not include a threaded cap. In this manner, even though a thread 138 is not necessary to secure a cap to the container 100, the discontinuities can still be used to allow air to freely vent from the receiving container. In implementations where the container does not include a threaded cap, the threads and discontinuities can be replaced by protrusions (e.g., ridges or bumps) and discontinuities (e.g., channels or gaps between protrusions) to provide similar venting functionality.

In some implementations, the interior surface of the receptacle 110 can be smooth. For example, the interior surface of the receptacle 110 can have an A-3 surface finish, as defined by the Society of Plastics Industry (SPI A-3). As another example, the interior surface of the receptacle 110 can be smoother (e.g., having a surface finish of SPI A-1 or A-2), or rougher (e.g., having a surface finish of SPI B-1 or rougher). A smooth interior surface of receptacle 110 can have a low friction coefficient that facilitates the delivery of powdered substances out of the container. This can be beneficial in some circumstances, for example, when it is desired that the substances stored within the container 100 slide easily across the interior surface of the receptacle 110 and out of the opening 114, so that they transfer quickly from the container 100 to a receiving container.

In some implementations, the interior surface of the 110 can include one or more textured portions. In some implementations, these textured portions can be relatively rougher than the smooth portions, such that the textured portions have a relatively higher friction coefficient than the smooth portions. In general, a variety of texturing can be used to achieve this. For instance, a random texturing pattern can be used. Alternatively or additionally, in some implementations, these textured portions can include surface structures, e.g., ridges, that impede the flow of a substance across its surface. This can be beneficial in some circumstances, for example, when it is desired that the substances stored within container 100 slide more easily across some surfaces (e.g., the smooth surfaces) than other surface (e.g., the textured surfaces). This may be desirable, for example, where the difference in flow of a substance over a textured portion relative to a smooth portion reduces the likelihood of the receptacle 110 clogging. For example, in some cases, having a receptacle 110 with an entirely smooth inner surface may result in a large amount of a powdered substance attempting to simultaneously flow out of the narrower opening 114. By having a receptacle 110 with some textured portions and some smooth portions, the powered substances along the textured portions are impeded and slide less easily across the surface of receptacle 110. Thus, a smaller amount of the powdered substance attempts to simultaneously flow out of the narrower opening 114, and the receptacle 110 is less likely to become clogged. Therefore, the substance is more likely to flow out of the container in a controlled and predictable manner.

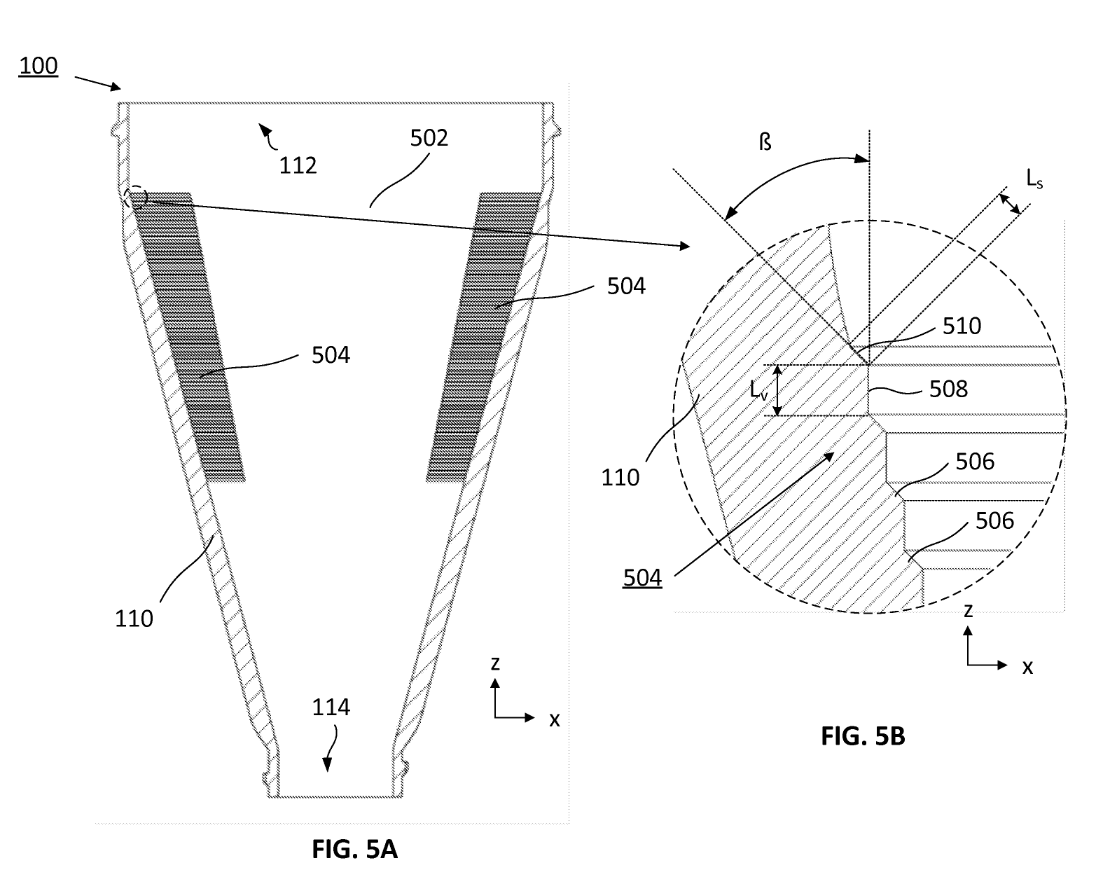

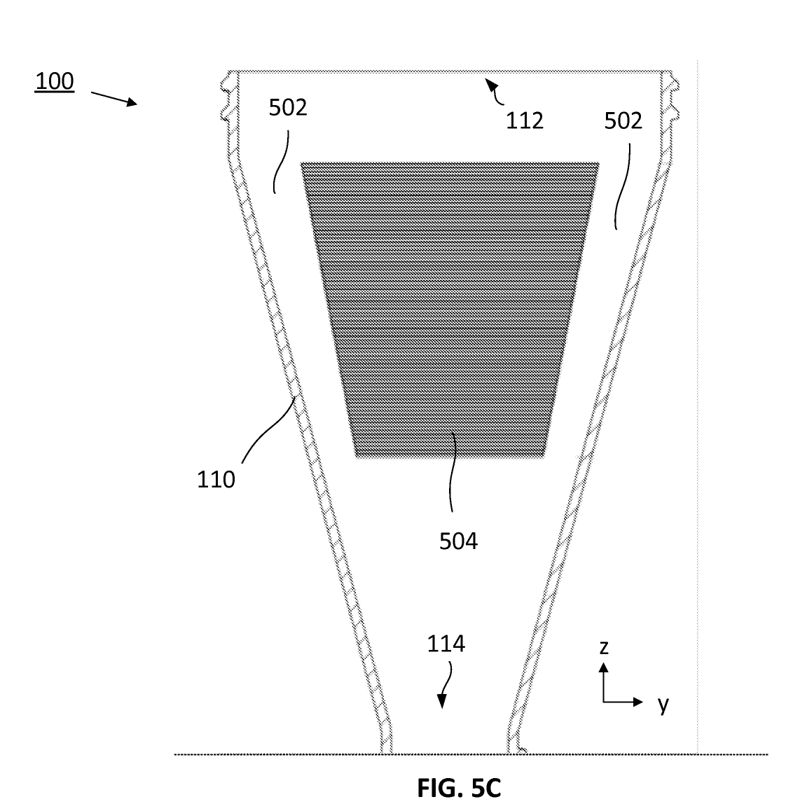

FIGS. 5A and 5C shows a front view (FIG. 5A) and side view (FIG. 5C) of an example implementation of a container 100 having smooth portions 502 and textured portions 504. In the implementation shown, the textured portions 504 can include several ridges defined along the inner surface of the receptacle 110. For example, FIG. 5B shows an example implementation of the textured portions 504 where each textured portion 504 includes a series of ridges 506 defined along the inner surface of the receptacle 110. In this example, the ridges 506 impede the flow of substances across their surfaces, and limit the amount of the substance that simultaneously attempts to flow out of the opening 114. Thus, substance along the smooth portions 502 more easily flow out of the opening 114.

In some implementations, the ridges 506 retain a portion of the substance that remains within the container 100 (e.g., as a mound of substance above the ridges 506 or a “bridge” of substance between two textured portions 504). A user can, for example, allow substance along the smooth portions 502 to exit the container 100 first, then agitate the container 100 so that the remaining substance is shaken loose from the ridges 506. In this manner, the receptacle 110 is less likely to clog from the initial release of substance from the container 100, and the user can controllably transfer the rest of the substance after the initial release of the substance.

In the example shown in FIG. 5B, each ridge 506 is defined by a vertical portion 508 and a sloped portion 510. The vertical portions 508 are parallel (or approximately parallel) to the axis of the container 100 (shown in FIG. 5B as the z-axis). The sloped portions 510 are angled with respect to the vertical portions 508, such that the ridge 506 protrudes from the receptacle 110 towards the center of the container 100. The angle β of the sloped portions 510 with respect to the vertical portions 508 can vary, depending on the implementation. As an example, in some implementations, the angle β can be approximately 45° (e.g., between 40° and 50°). In other implementations, the angle β can be between 5°-90° (e.g., 5°, 20°, 40°, 60°, 80°).

The lengths of the vertical portions 508 and the sloped portions 510 can also vary, depending on the implementation. For example, in some implementations, each vertical portion 508 can have a length Lᵥ of approximately 0.02 inches (e.g., between 0.15 and 0.025 inches). In some implementations, the length Lᵥ can be between 0.01 inches to 1 inch (e.g., 0.1 inches, 0.25 inches, 0.5 inches, 0.75 inches). In some implementations, each sloped portion 510 can have a length Lₛ of approximately 0.085 inches (e.g., between 0.06 and 0.011 inches). In some implementations, the length Lᵥ can be between 0.01 inches to 1 inch (e.g., 0.1 inches, 0.25 inches, 0.5 inches, 0.75 inches).

In an example usage, when the container 100 is filled with a powdered substance (e.g., a powered nutritional supplement) and the opening 114 is unsealed, the powder along the textured portions 504 are impeded by the ridges 506 and flows less easily along the surface of the receptacle 110. In contrast, the powered along the smooth portions 402 are relatively unimpeded and flow more easily along the surface of the receptacle 110. Thus, the amount of the powered substance that attempts to simultaneously exit the opening 114 is reduced, and the receptacle 110 is less likely to become clogged.

Although example angles and lengths are described above, these are merely examples. In practice, the lengths of the vertical portions 508 and the sloped portions 510, and the angle between these portions can vary, depending on the implementation. Further, although the ridges are described as being identical, in some implementations, some ridges may be different than others (e.g., having a vertical portion 508 with a different length Lᵥ, a sloped portion 510 with a different length Lₛ, and/or having a different angle β. Further, in some implementations, the vertical portions 508 need not be parallel to the axis of the container, and some or all of the vertical portions 508 can instead be sloped with respect to the axis of the container.

In some implementations, one or more of the ridges 506 can be parallel to an inner circumference of the receptacle 110, such that each ridge is parallel to the openings 112 and 114. In some implementations, one or more of the ridges 506 can be oblique with respect to the openings 112 and 114. In some implementations, the ridges 506 can define a spiral or other pattern within the inner surface of the receptacle 110.

Although example ridges 506 are described above, these are merely examples. In some implementations, ridges 506 can be defined using more than two portions (e.g., using three or more sloped portions and/or vertical portions). For example, a ridge 506 can be defined by a first sloped portion, a second sloped portion having a particular angle with respect to the first sloped portion, and a third sloped portion having another particular angle with respect to the second sloped portion. Further, although the example ridges 506 above are defined by straight portions, in some implementations, ridges 506 can be defined using curved portions (e.g., an arc or other curve).

The number of smooth portions 502 and textured portions 504 can vary, depending on the implementation. For example, in some implementations, the receptacle 110 can have a single smooth portion 502 or textured portion 504, such that the entire interior of the receptacle 110 is either smooth or textured. In some implementations, the receptacle 110 can have two textured portions separated by two smooth portions. For example, the receptacle 110 can have two textured portions on opposing sides of the receptacle 110, and be separated from each other by the smooth portions. In some implementations, the receptacle 110 can have more than two textured portions and/or more than two smooth portions.

In some implementations, the textured portions 504 and the smooth portions 502 can be approximately the same size or be of a different sizes. For example, in some implementations, there are two smooth portions 402 and two textured portions 504 that are all of the same size, and positioned such that they form quadrants about the interior of the receptacle 110. In some implementations, one or more of the smooth portions 402 and/or texture portions 504 can be of different sizes. For example, in some implementations, there are two smooth portions 502 and two textured portions 504, and the textured portions 504 are larger than the smooth portions 502. In practice, other combinations of smooth portions 502 and textured portions 504 are also possible.

In some implementations, the smooth portions 502 and textured 504s can extend completely or partially between the openings 112 and 114. For example, as shown in FIG. 5A, the smooth portions 502 extend completely along a length between the openings 112 and 114, while the textured portions 504 extend partially along a length between the openings 112 and 114. In practice, other arrangements of smooth and textured portions are possible, depending on the application. Although example containers are shown and described above, other implementations are possible. For example, in practice, a container can have different shapes, dimensions, and/or proportions than those described above. For instance, FIG. 6A shows an example implementation of a container 100 having a receptacle 110, a first cap 120, and a second cap 130. The dimensions of the container 100 of FIG. 6A are shown in FIGS. 6B-L (shown in inches, unless otherwise indicated). FIGS. 6A-L are each drawn to scale. FIG. 6B shows a side view of the receptacle 110, and FIG. 6C shows a cross-section of the receptacle 110 taken along line A-A of FIG. 6B (for simplicity, textured portions are not shown in FIG. 6C). “OD” refers to outer diameter. FIG. 6D shows a detailed view of the insert region B of FIG. 6C, and FIG. 6E shows a detailed view of the insert region C of FIG. 6C. FIG. 6F shows a bottom view of the receptacle 110, and FIG. 6G shows a top view of the receptacle 110. FIGS. 6H-J show a top view, bottom view, and side view, respectively, of the first cap 120 shown in FIG. 6A. “ID” refers to inner diameter. FIG. 6K shows a cross-sectional view of the first cap 120 taken along line A-A of FIG. 6H. FIG. 6L shows a detailed review of the insert region B shown in FIG. 6K. FIGS. 6M-O show a top view, bottom view, and side view, respectively, of the second cap 130 shown in FIG. 6A. The second cap 130 includes threads 602 that correspond to threads 138 of the receptacle 110, such that the second cap 130 can be attached to and detached from the receptacle 110 by rotating it with respect to the receptacle 110. FIG. 6P shows a cross-sectional view of the second cap 130 taken along line A-A of FIG. 6M. FIG. 6Q shows a detailed review of the insert region B shown in FIG. 6P.

FIG. 7A shows another example implementation of a container 100 having a receptacle 110, a first cap 120, and a second cap 130. The container 100 shown in FIG. 7A is generally similar to that shown in FIG. 6A, but having smaller dimensions and different proportions. The dimensions of the container 100 of FIG. 7A are shown in FIGS. 7B-L (shown in inches, unless otherwise indicated). FIGS. 7A-L are each drawn to scale. FIG. 7B shows a side view of the receptacle 110, and FIG. 7C shows a cross-section of the receptacle 110 taken along line A-A of FIG. 7B (for simplicity, textured portions are not shown in FIG. 7C). FIG. 7D shows a detailed view of the insert region B of FIG. 7C, and FIG. 7E shows a detailed view of the insert region C of FIG. 7B. FIG.

7F shows a bottom view of the receptacle 110, and FIG. 7G shows a top view of the receptacle 110. FIG. 7H-J show a top view, bottom view, and side view, respectively, of the first cap 120 shown in FIG. 7A. FIG. 7K shows a cross-sectional view of the first cap 120 taken along line A-A of FIG. 7H. FIG. 7L shows a detailed review of the insert region B shown in FIG. 7K. In this example, the second cap 130 can be similar to that shown in FIGS. 6M-Q.

Containers having other shapes, dimensions, and/or proportions are also possible, depending on the implementation.

In general, the containers can be formed from a variety of materials, such as plastics, glasses, or a metal or alloy (e.g., aluminum or stainless steel). In some implementations, the containers are formed from a plastic considered safe for storage of food or other nutritional products. Useable plastics may include, for example, polyvinyl chloride (PVC), polystyrene, polycarbonate, polyethylene terephthalate ethylene, high-density polyethylene, low-density polyethylene, and polypropylene (PP). Useful glasses include, for example, commercially-available glasses used for kitchenware or laboratory purposes, e.g., Pyrex. In some implementations, the containers can be formed from a ceramic material.

In some embodiments, containers are formed from cardboard, e.g., with a plastic liner to provide adequate sealing for liquid storage.

In general, the caps and receptacle can be formed from the same material, or from different materials. For example, the receptacle can be formed from a glass, while the caps are formed from a plastic.

The containers can be formed using a variety of known methods, such as injection molding (e.g., for plastic containers) or conventional glassware-shaping methods (e.g., for glass containers).

Further, although the example containers described above are generally conical (e.g., having a relatively wide opening at one end and a relatively narrow opening at the other), this need not be the case. For example, in some implementations, the containers can be generally cylindrical, spherical, polyhedral, or have an arbitrary shaped volume.

In general, the containers disclosed herein can be used for a variety of purposes. For example, they can be used by consumers for the storing, transport, and transfer of pre-measured amounts of a nutritional substance. For example, containers can be used to store, transport, and/or transfer pre-measured amounts of an infant formula, a nutritional supplement (e.g., a protein powder or other dietary supplement), or ground or granular food (e.g., sugar, ground coffee, flour, powdered milk). The volume of such containers can correspond to one or more servings (e.g., one, two, three, or four or more scoops) of the infant formula or nutritional supplement. Containers can be used to store, transport, and/or transfer pharmaceutical products, such as powdered or liquid pharmaceuticals.

Implementations of the above described containers can be used by airline passengers to store, transport, and/or transfer airline-security-permitted volumes (e.g., 3.4 oz, 100 ml or less) of liquids or powders in their carry-on luggage. For example, travelers can use containers to store airline-security-permitted volumes of toiletries or nutritional substances.

Implementations of the above described containers can also be used in a medical or laboratory environment. For example, containers can be used to transport, store and/or transfer medical specimens. In a laboratory, containers can be used to transport, store, and/or transfer, e.g., specimens or reagents.

A number of embodiments of the invention have been described. Nevertheless, it will be understood that various modifications may be made without departing from the spirit and scope of the invention. For example, in some embodiments one or both caps can include a valve (e.g., a stopper that plugs a small opening in the planar portion of the cap) that allows one to purge the receptacle volume while emptying the container through the opposite opening. Such a valve can prevent formation of vacuum in the container that hinders removal of the liquid or substance from the container.

Moreover, while embodiments are disclosed for the transfer and storage of powdered substances are disclosed, aspects of these embodiments can be implemented in other environments. For example, use of textured versus smooth surfaces to facilitate transfer of a powdered substance under gravitational flow can be used in other environments, such as industrial environments like manufacturing lines, where powdered substances are to be funneled through a relatively narrow opening.

Accordingly, other embodiments are within the scope of the following claims.

What is claimed is:

1. A container, comprising:
a receptacle having a first opening and a second opening opposite the first opening and a through passage extending between the first and second openings, the first opening being larger than the second opening;
a first cap shaped to seal the first opening; and
a second cap shaped to seal the second opening,
wherein an inner surface of the receptacle comprises a pair of textured portions on opposing sides of the through passage, the textured portions being separated by smooth portions.

2. The container of claim 1, wherein the textured portions and the smooth portions are configured such that when the container is positioned with the first opening over the second opening and a fine grained substance is disposed within the receptacle, the fine grained substance moves towards the second opening more freely along the smooth portions than along the textured portions.

3. The container of claim 1, wherein each textured portion comprises a plurality of ridges.

4. The container of claim 3 wherein each ridge is parallel to an inner circumference of the receptacle.

5. The container of claim 1, wherein the container further comprises a first group of threads defined along the receptacle about the first opening, wherein the first group of threads are adapted to engage the first cap when the first cap is sealed to the first opening.

6. The container of claim 5, wherein the first group of threads comprises discontinuities in a circumferential direction about the first opening.

7. The container of 5, wherein the container further comprises a second group of threads defined along the receptacle about the second opening, wherein the second group of threads are adapted to engage the second cap when the second cap is sealed to the second opening.

8. The container of claim 7, wherein the second group of threads defines an outer periphery with a diameter in a range from 0.70 inches to 0.85 inches.

9. The container of claim 7, wherein the second group of threads comprises discontinuities in a circumferential direction about the second opening.

10. The container of claim 6, wherein the discontinuities are configured such that the first opening is unsealed when the first cap is rotated with respect to the container from a sealed position to an unsealed position, wherein the first group of threads remain engaged with the first cap in the unsealed position.

11. The container of claim 10, wherein the container further comprises one or more external ridges extending along an outer surface of receptacle between the first opening and the second opening.

12. The container of claim 11, wherein the first cap comprises a seal indicator; wherein when first cap is in the unsealed position, the seal indicator is aligned with a particular one of the external ridges or another marker

13. The container of claim 1, wherein the receptacle defines a conical volume.

14. The container of claim 1, wherein the container is adapted to retain a fine grained substance within the receptacle when the first cap is sealed to the first opening and the second cap is sealed to the second opening.

15. The container of claim 14, wherein the fine grained substance is a nutritional supplement.

16. The container of claim 15, wherein the fine grained substance is pharmaceutical substance.

17. A container, comprising:
a receptacle having a first opening and a second opening opposite the first opening and a through passage extending between the first and second openings, the first opening being larger than the second opening;
a first cap shaped to seal the first opening;
a second cap shaped to seal the second opening; and
a group of threads defined along the receptacle about the first opening, the group of threads adapted to engage the first cap when the first cap is sealed to the first opening,
wherein the group of threads comprises discontinuities in a circumferential direction about the first opening, the discontinuities configured such that the first opening is unsealed when the first cap is rotated with respect to the container from a sealed position to an unsealed position, and
wherein the group of threads remain engaged with the first cap in the unsealed position.

18. A container, comprising:
a receptacle having a first opening and a second opening opposite the first opening and a through passage extending between the first and second openings, the first opening being larger than the second opening;
a first cap shaped to seal the first opening; and
a second cap shaped to seal the second opening,
wherein the second opening defines an outer periphery with a diameter in a range from 0.70 inches to 0.85 inches.
